(19) United States
(12) Patent Application Publication
(10) Pub. No.: US 2009/0236542 A1
(43) Pub. Date: Sep. 24, 2009

(54) OPTICAL INSPECTION

(75) Inventor: David John Wallis, Malvern (GB)

Correspondence Address: OLIFF & BERRIDGE, PLC, P.O. BOX 320850, ALEXANDRIA, VA, 22320-4850, US

(73) Assignee: QINETIQ LIMITED, London (UK)

(21) Appl. No.: 12/302,745

(22) PCT Filed: Jun. 1, 2007
(86) PCT No.: PCT/GB2007/002036

§ 371 Date: Nov. 26, 2008

(30) Foreign Application Priority Data
Jun. 7, 2006 (GB) 0611156.1

(51) Int. Cl. G01J 1/58; G01N 21/59; G01B 11/24; G01J 4/00

(52) U.S. Cl. 250/459.1; 356/432; 356/51; 356/496; 356/364; 356/450; 250/208.1

(57) ABSTRACT

This invention relates to methods of determining physical characteristics of and identifying and locating defects in substrates, such as semiconductor wafers, optical thin films, display screens and the like. The method involve use of PC scanners to image the substrate. In particular PC scanners used in transmission mode imaging allow information about the volume of the substrate to be determined. The method allows determination of characteristics such as layer thickness, curvature and optical constants through use of interferometery techniques and bifrefringence and strain through use of polarised imaging. The methods also relate to stimulating luminescence in the substrate, for example photoluminescence and electroluminescence and scanning the stimulated substrate for luminescence mapping.

This invention relates to a method of optical inspection of wafers, especially semiconductor substrate wafers and particularly to a method of inspection using low cost and readily available technology.

Semiconductor substrate wafers are used as the basis for growth and fabrication of a large number of electrical devices. The quality, uniformity and characteristics of the semiconductor wafer can have a significant effect on the devices and their yield and hence there is a need to be able to inspect the semiconductor substrates.

Industry standard tools for the inspection of semiconductor wafers exist and these generally involve scanning a laser spot over the surface of the wafer. For non-transparent substrates this scanning can provide information regarding surface characteristics and morphology. These tools are typically quite expensive however and may be beyond the budget of many smaller wafer users and research labs.

US2003/0095252 describes a method and apparatus for defect analysis of wafers which uses a flatbed scanner to scan wafers. This offers a simple and inexpensive way to obtain a reflection image of the wafer which can be used for defect analysis. However other characteristics of the wafer which are useful to determine, such as thickness or curvature need to be determined in other ways.

It is therefore an object of the present invention to provide a means of inspecting and determining physical characteristics of part or complete wafers up to 150 mm diameter, or possibly larger, especially semiconductor substrates, which is low cost. Thus according to the present invention there is provided a method of inspecting a substrate comprising the step of scanning the substrate with a PC scanner having negative imaging capability so as to record the intensity of light transmitted through the substrate.

The present invention is performed using a PC scanner having negative imaging capability as purchased or with only minor modifications. As used herein the term PC scanner shall mean an imaging device operated and controlled as a peripheral device to a personal computer. Most standard imaging PC scanners illuminate a document to be scanned with white light and scan a linear detector array relative to the document to detect light reflected from the document. Negative image scanners are arranged to detect light which is transmitted through an item such as a negative and therefore have at least one detector array arranged relative to the light source for detection of transmitted light. Provided that such a scanner has a high enough resolution the resulting image information can be used to determine various material characteristics. Using conventional scanners obviously allows a very low cost solution with scanners being readily available. Increasingly scanners are available which allow both reflective mode and transmission mode imaging and such scanners can be used in the present invention to acquire images in both transmission and reflection.

US2003/0095252 does teach that a flatbed, i.e. reflection mode, scanner can be used in defect analysis of a wafer but in effect simply records a standard reflection image which can be viewed to locate defects. The method of the present invention uses light transmitted through the substrate so as to determine at least one physical characteristic such as layer thickness, surface bow or curvature, refractive index, strain etc. Prior to the present invention the skilled person would not have thought that a PC scanner was a suitable piece of equipment for measuring the thickness or curvature of a substrate such as a wafer. The present inventors have realised however that the information collected by use of a scanner is sufficient to allow useful wafer characterisation.

Conveniently the detector array of the PC scanner comprises a number of elements receiving light at a single or several different wavelengths, for example at wavelengths corresponding to red, blue and green light. At least some detector elements may also detect the intensity of infrared radiation. Note as used herein the term light shall include visible radiation and also non-visible radiation, for instance infrared radiation and ultraviolet radiation. The term white light means that the light source may have a broad continuous emission spectrum or consist of strong emission lines in at least the red, green and blue parts of the visible spectrum.

The present invention therefore uses a white light source to illuminate the substrate and detects the intensity of radiation transmitted through the substrate. The detector array detects the intensity at different wavelengths and wavelength dependent differences in the received intensity can be used to determine various material or device characteristics. The substrate may be a semiconductor wafer such as used in device fabrication. The substrate may also be an optical thin film or any other optical structure, for instance a display.

The method of the present invention requires at least some light to be transmitted through the substrate and hence the substrate must be at least partially transparent at a wavelength of illumination. Some semiconductor substrates are transparent at visible or near infrared wavelengths, e.g. SiC, Al₂O₃, GaN, AlN and InN, and hence the method can be usefully applied thereto. The light source and detector array of the scanner may be adapted to operate at one or more non visible wavelengths at which a particular substrate or wafer is transparent, allowing the intensity of light transmitted to be detected. This could be useful for materials such as GaAs, InP or CdSe. The measurement of light transmitted through the wafer allows the volume of the wafer to be inspected and not just its surface. This can reveal information about defects in the wafer, allowing defect locations to be identified and defect densities to be assessed.

Transparent wafers can also be inspected by measuring the radiation reflected or scattered from the wafer. Used in conjunction with the method of the present invention reflection/scattering based imaging can reveal additional information about the wafers.

The thickness of the wafer can also be determined by comparing the intensities recorded at different wavelengths. Light being transmitted through the wafer will be reflected from the wafer/air interfaces and any interfaces within the wafer. The wafer effectively forms a Fabry-Perot etalon and therefore the intensity of light transmitted from the device will depend on the optical thickness at a particular wavelength. By looking at the intensity difference between different wavelengths, the absolute thickness of the wafer can be determined. Even looking at one wavelength, thickness variations can be determined. Further more, optical constants such as refractive index and absorption of unknown layers may also be determined.

As the skilled person will appreciate radiation which is transmitted through the wafer will comprises some radiation that has been directly transmitted through the wafer. It will also comprise some radiation which is reflected from the front wafer/air interface and reflected again from the rear wafer/air interface before exiting the wafer. This doubly reflected radiation will interfere with the radiation which is directed transmitted. The interference may, of course, be constructive or destructive depending upon the optical path difference and the particular wavelength. The optical path difference will vary with angle of incidence and hence looking at any narrow wavelength band one may see interference fringes. Using only a single narrow band of wavelengths one can only determine relative thickness of the wafer. However by looking at different images at different channels, i.e. taking each image formed by the red, green and blue channels of the detector array separately one can measure the fringe spacing for each wavelength and therefore determine the absolute thickness. Thus the present invention provides a method of determining absolute thickness of a wafer using a simple scanner.

The same technique can be used to determine surface curvature. If the wafer is placed on a transparent surface of known curvature, either the scanner glass surface or preferably an optical flat, any gaps between the optical flat and the wafer will act as etalons themselves. Thus interference fringes due to the surface curvature will also be produced and can be detected and measured.

The method may involve using the detected intensities to determine at least one of the magnitude of wafer curvature, variations in substrate thickness, variations in epi layer thickness, surface particulate and/or scratch density and location and/or density of crystallographic defects such as micropipes and crystal tilts.

The method may involve the step of arranging the detector array of the PC scanner to only receive radiation of a particular polarisation. The method may also involve illuminating the wafer with polarised radiation. This may conveniently be achieved by arranging a polariser between the source and the wafer and/or a polariser between the wafer and the detector array. The polarisers may be arranged in the optical path in a matched configuration, i.e. both allow the same polarisation to pass, or in crossed configuration or any variant in between. The use of crossed polarisers in the optical path can give contrast due to birefringence and can yield useful information about the strain present in a wafer. This particularly useful for SiC wafers.

The present invention is particularly useful for imaging semiconductor substrates, and can be used at any stage of material growth/device fabrication. For instance a substrate may be inspected prior to any epi layer growth to ensure it is reasonably defect free and of accepted thickness and curvature. Following epi layer growth the wafer could be inspected again to ensure acceptable growth has occurred. The wafer could also be inspected after various processing steps. For instance if metal tracks are deposited to form contacts etc. the wafer could be inspected after deposition and any necessary etching to ensure the correct deposition has occurred.

Further the information from each stage in the process can be compared or collated. For instance the location of a defect that occurs at particular stage of processing can be compared to the information regarding local defects, thickness variations, strain etc. acquired from previous stages which may inform future quality controls and/or processing steps. The present invention may therefore also comprise a method of fabricating a semiconductor device on a substrate comprising the step of inspecting the semiconductor device and/or substrate at least once using the method as described above.

The present invention is however applicable to other substrates. For instance optical thin films, such as anti-reflection coatings, etc. are used in various applications and again thickness and defect density can affect usefulness. The present invention is therefore applicable to the inspection of the characteristics of any substantially planar substrate which, for the purposes of this specification shall be termed a wafer. The wafer may comprise a composite item, for instance the present invention could be used to inspect the quality of display devices, such as Liquid crystal displays, in terms of thickness variations, optical variation, defect densities etc.

As mentioned above the method of the present invention can conveniently be employed using a PC scanner. The present invention therefore relates to the use of a personal computer having a transmission mode imaging scanner peripheral to determine a physical characteristic of a wafer. The method may involve the step of determining one of wafer thickness and wafer surface curvature. Conveniently the personal computer is programmed to automatically determine the wafer characteristic from the data collected by the scanner.

Whilst use of white light is advantageous in that it allows measurement of intensity at different wavelengths and most standard commercial scanners use white light sources, there are some applications where it may be useful to alter the wavelength of illumination. For instance, as mentioned, several semiconductor substrates are transparent at infrared wavelengths, for example, GaAs, InP, Si, GaSb and InSb and therefore operating at infrared wavelengths would allow the same whole wafer analysis to be applied to these substrates. In many cases, where the material of interest has a band gap that is larger than that of Si the method of the present invention may be achieved simply by modifying only the illumination source of the scanner. As the detector commonly used in film scanners is a Si based CCD, the detector will already be sensitive to IR radiation down to 1.1 eV. For semiconductors with a band gap below 1.1 eV the detector would also need to be modified.

In another embodiment, where semiconductor materials are used, the energy of illumination source could be chosen to be above the bandgap of the material so as to excite photoluminescence. Thus illumination of the semiconductor at this wavelength will cause luminescence at a particular wavelength or group of wavelengths. The intensity of luminescence can be measured and mapped across the full area of the wafer. In some cases, for example InGaN devices, this photoluminescence mapping may be performed by inserting an optical filter in front of the light source so that only the wavelengths above the band gap of the material (e.g. blue) are passed and then detecting the emitted photoluminescence in the longer wavelength channels (e.g. red or green). The detector of the scanner could also be usefully used to map electroluminescence of devices by turning off the illumination source and then scanning the wafer or device as the wafer is electrically stimulated to excite luminescence.

As mentioned above the method of the present invention may be conveniently implemented using a PC scanner. In another aspect of the present invention there is provided a computer programme for controlling a scanner connected to a personal computer to optically inspect a wafer and based on the image data acquired, determine at least one of epi layer/wafer thickness and wafer curvature. The invention also provides a kit for wafer inspection comprising a personal computer, a scanner and a computer programme for controlling the scanner to optically inspect a wafer.

As described above the method of the present invention allows use of a PC scanner in determining physical characteristics of the wafer, especially layer thickness and/or curvature. Thus in another aspect of the invention there is provided a method of determining the thickness and/or curvature of a wafer layer comprising the steps of using a scanner to obtain an image of the wafer, detecting and measuring interference fringes in the image and, from said measurements, determining the thickness and/or curvature of said wafer layer.

As used above the term scanner here means an imaging device which is a peripheral device connectable to a personal computer. The method according to this aspect of the present invention can be performed in reflection mode or transmission mode and hence the scanner may be of the flatbed document scanning (reflective imaging) type or the negative imaging (transmissive imaging) type or preferably be a scanner operable in both modes.

As mentioned above radiation transmitted through the wafer will interfere with radiation doubly reflected within the wafer resulting in the formation of interference fringes. The same happens in reflection (provided the wafer itself is at least partially transparent) with radiation reflected from the front air/wafer interface interfering with radiation reflected from the rear wafer/air interface.

As above the method according to this aspect of the invention preferably involves analysing the image formed by each wavelength channel of the scanner detector array separately. The method may involve placing the step of imaging the wafer on an optical flat to determine surface curvature.

The method may further involve the step of determining the refractive index of the wafer.

The use of polarisers to determine information regarding birefringence and/or strain of a wafer is also another aspect of the present invention which is applicable to both transmissive mode imaging and reflective mode imaging. Thus according to another aspect of the invention there is provided a method of imaging a wafer using a PC scanner wherein at least one polariser is located in the optical path from the source to detector.

One polariser may be located between the source and the wafer so as to illuminate the wafer with polarised light. Some defects have a sensitivity to polarised light and may show up with greater contrast using a polarised light source as oppose to imaging with unpolarised light. The method may involve taking one image of the wafer with polarised light of one polarisation state followed by a second image using polarised light of a different polarisation state, i.e. where linear polarisers are used images may be taken using a first linear polarisation followed by an orthogonal linear polarisation. The images may be compared to identify defects.

The method may involve locating one polariser between the light source and the wafer and another polariser between the wafer and the detector. Using a transmission mode this can be easily accomplished by locating one polariser either side of the wafer. The method may involve using linear polarisers and may involve imaging between crossed polarisers, i.e. the source side polariser is arranged to transmit a light with a linear polarisation which is orthogonal to that of the detector side polariser, or through aligned polarisers, i.e. both the source and detector side polarisers are arranged to transmit polarised radiation of the same orientation. The image recorded can be analysed to determine the degree of birefringence of the wafer and/or the amount of strain in the wafer. As the skilled person will appreciate strained wafers may rotate polarised light passing through the wafer and hence the amount of light transmitted through crossed polarisers can give a measure of the amount of strain in the wafer and highlight the strained locations.

The use of a scanner for electroluminescence and/or photoluminescence constitutes another aspect of the invention. Thus according to another aspect of the invention there is provided a method of analysing a wafer comprising the step of stimulating luminescence within the wafer whilst imaging the wafer using a scanner. The stimulation may be through use of illuminating radiation having an appropriate wavelength to stimulate photoluminescence. Alternatively the method may involve electrically stimulating electroluminescence within the wafer. When electrical stimulation is used the light source of the scanner may be disconnected so that only electroluminescence is detected. Alternatively the wafer could be imaged as usual using a light source at a different wavelength to the stimulated luminescence and images at different wavelengths recorded. This aspect of the present invention allows photoluminescence and/or electroluminescence maps to be quickly and simply generated over whole wafers.

The invention will now be described by way of example only with respect to the following drawings of which;

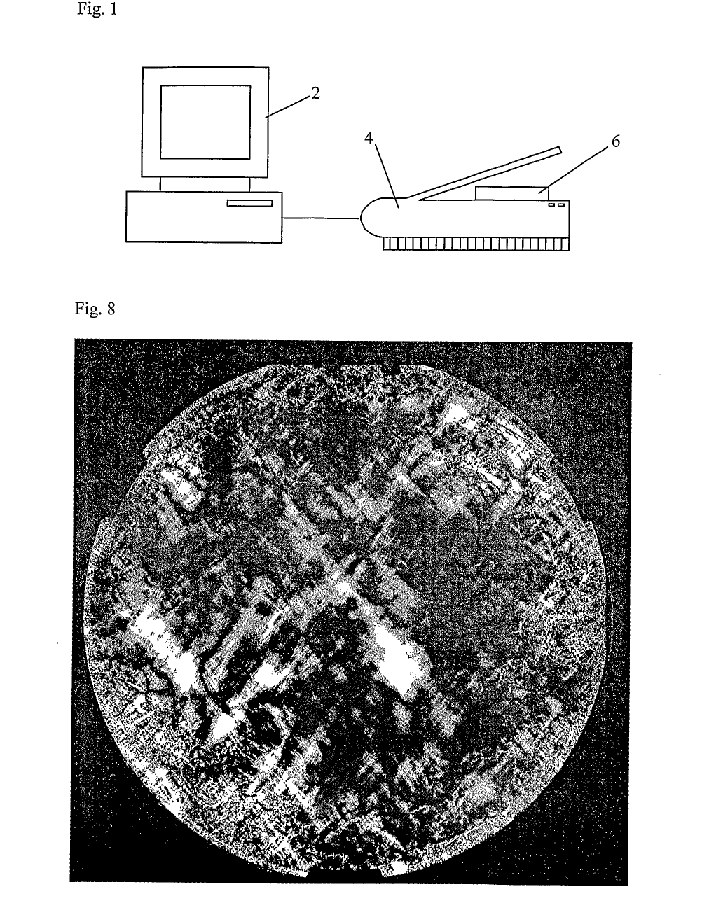

FIG. 1 shows a schematic of an apparatus for the optical inspection of a wafer using the method of the present invention,

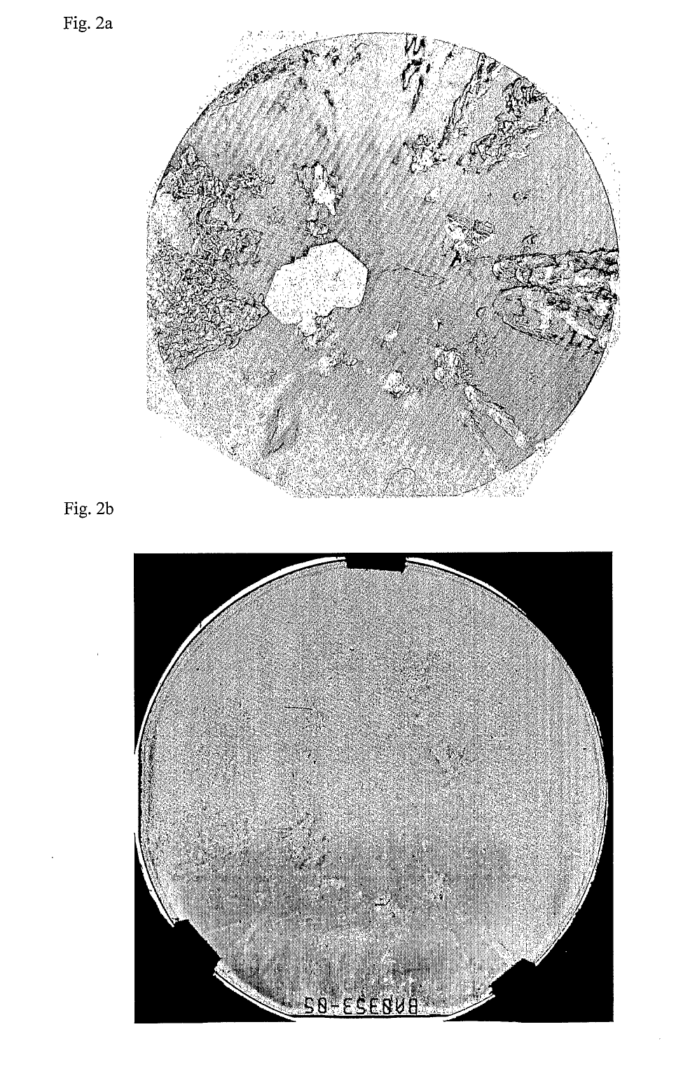

FIG. 2 shows the comparison of an X-ray topograph of a Gallium Nitride on silicon carbide layer and a scanned image of the same layer acquired using the method of the present invention,

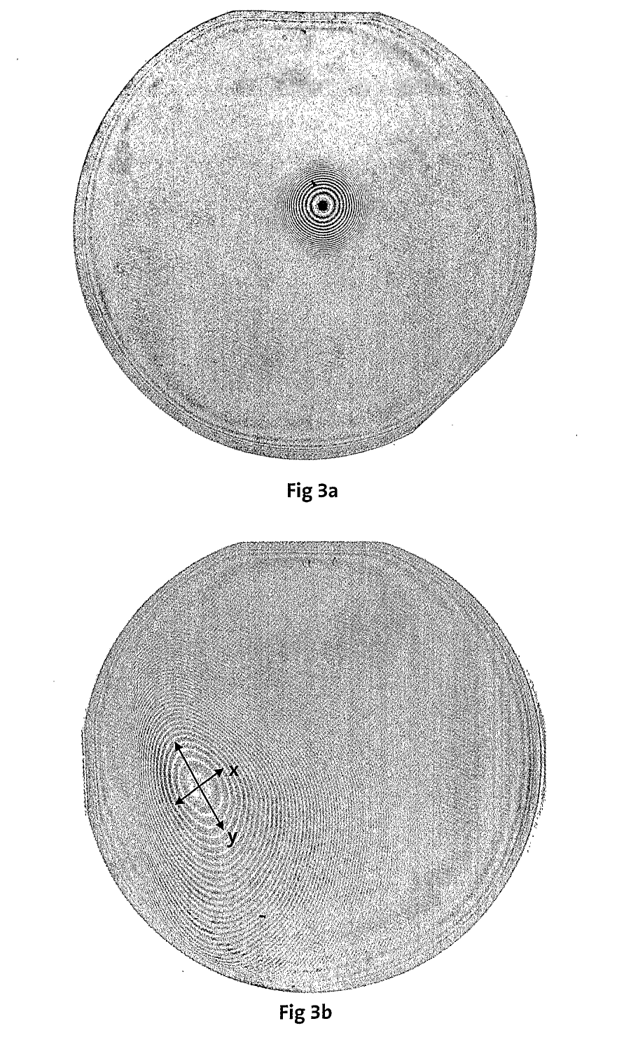

FIG. 3 shows scanned images of two different sapphire substrates,

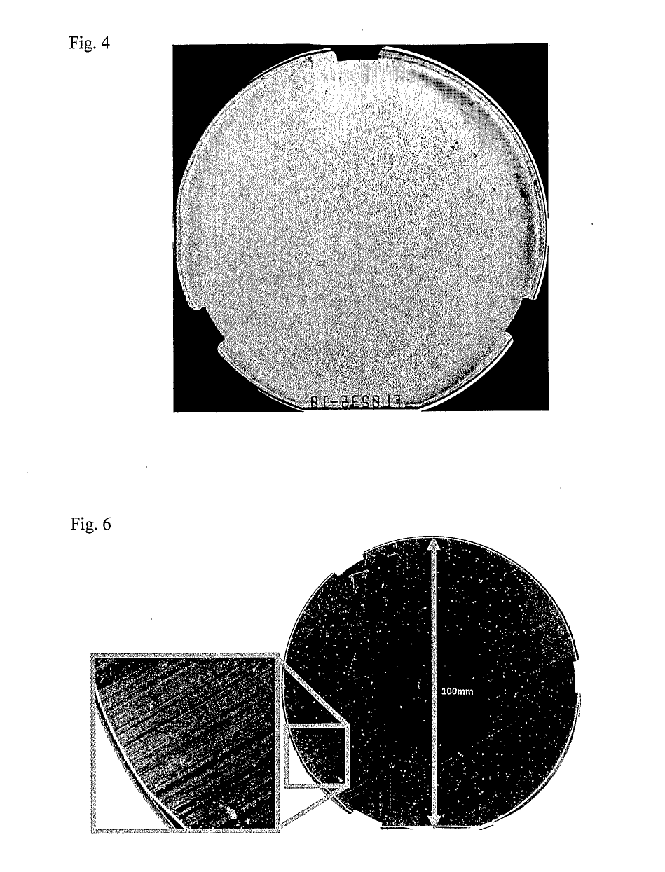

FIG. 4 shows a scanned image with enlargements of a GaN on SiC wafer,

FIG. 5 shows the red, green and blue channel images for a Gallium nitride on silicon carbide wafer,

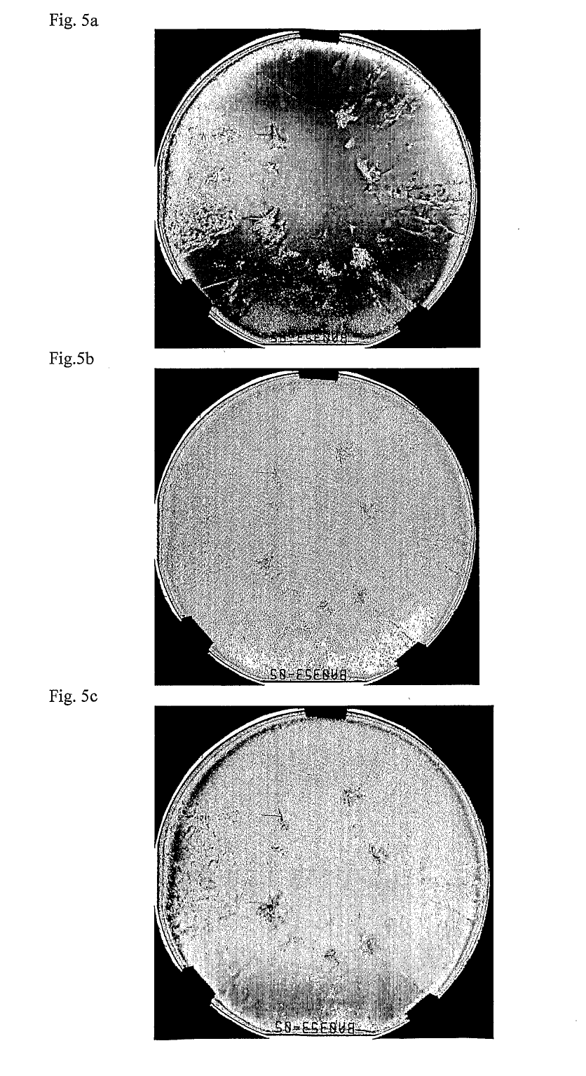

FIG. 6 shows a scanned image of a GaN on Si wafer,

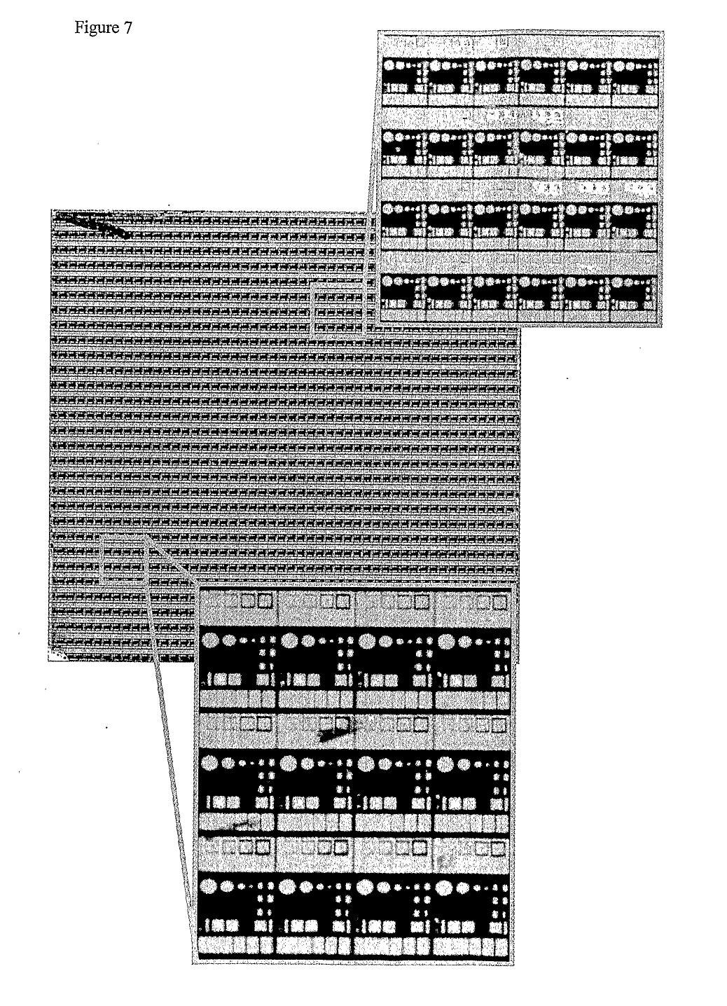

FIG. 7 shows a scanned image of a GaN on Si substrate having device structures processed thereon, and

FIG. 8 shows a scanned image acquired between crossed linear polarisers.

Referring to FIG. 1 a personal computer 2 is connected to a scanner peripheral 4. The scanner may be any commercially available colour scanner designed to allow scanning of both standard documents and film negatives or slides. However useful scanning of wafers can be done using a flatbed scanner for imaging documents imaging in reflective mode or alternatively a negative scanner imaging in transmission mode. A scanner resolution of 2000 dots per inch allows identification of wafer features on the scale of 30 μm, however higher resolution scanners are available with resolutions of 4800 dpi and 6400 dpi giving data with resolutions around 10 to 8 μm. Clearly, as film scanner technology develops, higher resolutions will become available enabling useful imaging of wafers at higher resolutions

The scanner may be a typical A4 size scanner. For instance the Canon 9950F or Epson Perfect V700 Photo. Flat bed scanners suitable for imaging documents of A3 size are also available and could be used to allow imaging of larger area wafers such as 300 mm Silicon. For instance the Epson Expression 10000 A3 Flatbed scanner.

The computer 2 is programmed to control the scanner 4 to acquire an image of a wafer 6. The wafer may be placed onto the standard scanner imaging surface or preferentially the glass may be removed from the scanner bed and replaced with a custom holder for the particular wafer. By removing the glass, contamination of the wafer can be avoided and effects due to particulates, scratches or reflections from the glass are removed. The wafer may, for instance, be a semiconductor wafer which is substantially transparent at visible wavelengths such as Silicon Carbide, sapphire, Gallium Nitride, Aluminium Nitride and Indium Nitride. Alternatively the wafer may be Gallium Arsenide, Silicon, Gallium Antimonide, Indium Arsenide, Indium Antimonide, Indium Phosphide, Gallium Phosphide or any common semiconductor wafer which is not transparent at visible wavelength.

Wafers of up to 150 mm diameter or larger may be imaged easily on standard commercially available scanners. Larger area scanners are available which could be used to image larger wafer sizes. The thickness of the wafer may be up to about 25 mm thick, although for thicker wafers the information obtained may be limited as part of the wafer will be outside the focal plane of the detector.

As the skilled person will be aware to acquire the image the scanner illuminates the area of the scanner imaging surface with a fluorescent mercury vapour tube. This light source is a white light source and produces strong coherent spectral lines at particular wavelengths in the red, green and blue parts of the visible spectrum for example 611 nm, 543 nm and 434 nm, although the exact wavelength may vary from manufacture to manufacture. The light source may also consist of arrays of Light Emitting Diodes emitting at similar wavelengths in the red, green and blue or a Xenon arc lamp. An IR light source, operating at about 815 nm, is also often included in the scanner for the correction of defects in film negatives (scratch detection). This IR source may also be usefully employed for imaging semiconductor wafers.

As the imaging area is illuminated, the scanning head is moved relative to the imaging area. The scanning head contains an array of CCDs mounted in a linear area with separate arrays arranged to detect red, green and blue light. There may also be an infrared receiving array.

Each detector array measures the intensity of the radiation reflected (scattered) or transmitted from the scanning area in the particular wavelength band and effectively three (or 4 including IR) images are produced. FIG. 2a shows an X-ray topograph of a 50 mm GaN on SiC wafer which is approximately 300 μm thick. As the skilled person is well aware X-ray topography is a well known imaging technique for volume mapping of crystalline materials. X-ray topography can give good quality images revealing the location and nature of crystalline defects but acquiring an X-ray topograph requires specialised equipment and takes a great deal of time. A full wafer X-ray topograph can take many hours to acquire.

FIG. 2b shows the same GaN on SiC wafer imaged using a scanner according to the present invention. The image is an image of light transmitted through the wafer and is formed from all three channels, red, green and blue and so represents a colour image. It can be seen that features in the scanned image can be directly correlated with crystallographic defects in the X-ray topograph. The image of FIG. 2b was acquired in less than 120 seconds.

Therefore despite the fact that the skilled person would not think of a PC scanner as an optical inspection tool and would think such a scanner would be unable to produce useful information the present inventors have shown that useful information can be obtained in a high speed and low cost manner.

FIG. 3 shows reflection scanned images of two different sapphire substrates having a Gallium Nitride layer formed thereon. These are images which were produced by imaging the wafer through the glass of the scanner, using intensity data from the green channel only. The fringes seen in the image are produced from interference of the strong 543 nm emission line of the mercury vapour source. The high frequency fringes, seen in both images, are due to reflections arising at the wafer surface and the glass plate of the scanner and are therefore indicative of the height of the wafer surface above the glass, or the wafer curvature. Therefore by measuring the fringe spacing and taking the wavelength of illumination as 543 nm the degree of curvature can be estimated. For the wafer shown in FIG. 3a the radius of curvature is calculated to be approximately 6 m (convex) and for the wafer shown in FIG. 3b the radius of curvature can be calculated to be approximately 10 m in the x-direction and 23 m in the y-direction.

Some low frequency fringes can also be seen in both images which is due to interference between reflections from the wafer surface and the GaN/Sapphire interface. This gives a map of the thickness changes of the GaN layer. Again taking the wavelength as 543 nm and a refractive index for GaN of 2.4, a transition from a bright fringe to a dark fringe corresponds to a thickness change of approximately 40 nm.

It can therefore be seen that information from the various channels can be used to give indications of the dimensions of the wafer and epi layers formed thereon.

FIG. 4 shows an image of a GaN on SiC wafer with enlargements of specific areas. In this case small variations in the thickness of the GaN epilayer are seen in some regions of the wafer due to an islanded growth mode. These islands are approximately 30 μm across and 30 nm high. It can be seen that the present invention can be used to gain detailed information about the surface morphology of a semiconductor layer and how this morphology changes across a complete wafer. In turn this information may be used to inform and modify the growth parameters and to correlate with variations in device performance and yield across wafers.

It is also possible to compare the data from different channels. FIG. 5a shows the intensity of transmitted light through a GaN layer on a SiC substrate recorded by the red channel. FIGS. 5b and 5c shows the same intensity image for the green and blue channels for the same wafer. The fringe spacing in the three images is different due to the different wavelengths, 611 nm in the red channel, 543 nm in the green channel and 434 nm in the blue channel. The difference in fringe spacing can be used to determine the absolute thickness of the GaN epilayer, and also its optical constants such as refractive index. Further, the different contrast in the colour channels around defects may be used to categorise and identify particular defect types.

FIG. 6 shows a scanned image of a GaN on Si wafer. Since the Si substrate is non-transparent at the wavelengths used, this image is collected in reflection mode. Clearly seen in the image is a network of line defects which are cracks which occur in the GaN layer due to strains introduced during growth. These features are imaged due to the fact that they scatter the light reflected from the wafer surface. This image also shows points of white contrast which are due to particulates on the wafer surface indicating that defect maps and densities can also be produced on non-transparent wafers.

Referring back to FIG. 1 the computer 2 controls the scanner 4, which may be a reflective scanner or a transmission scanner, to take an image of the wafer. Having acquired an image of the wafer the computer can apply a variety of image processing techniques. Defects in the wafer can be identified by appearance of discrete contrast variations in the images of all three channels. Areas of likely defects can be highlighted to an operator or a count of defects and their size or type could be performed and a defect density given. Furthermore any fringe patterns in the images could be identified and the fringe spacing/thickness determined. Having determined the fringe spacing the thickness, or optical constants of the wafer/substrate, can be determined and mapped across the wafer using knowledge of the wavelength of each channel.

The present invention can also be applied to scanning wafers which have some device processing thereon. Images could be acquired of the processed wafer to detect any defects in the device structure, such as residues remaining after etching steps etc. or incorrect device formation. Such imaging could be carried out as convenient breaks in the processing stages to ensure quality. FIG. 7 shows a scanned image of a GaN on Si wafer with device processing. The images show evidence for debris in the gaps of the devices which could be correlated with electrical results and would show up as short circuits. Evidence of resist residues can also be seen.

The wafer could also be scanned prior to device processing or during device processing. Any areas of device structure failure or other defects could be identified. It may be possible to correlate defect areas with particular substrate features, thus informing future device processing or screening processes to improve yield.

The wafer may also be imaged using one or more polarisers to provide further information about the physical characteristics of the wafer. For instance a linear polariser may be placed between the source and the wafer so as to illuminate the wafer with polarised light. The orientation of the polariser may be changed from time to time between orthogonal orientations. Some wafer features may have particular polarisation responses and hence may be identified more clearly when the wafer is illuminated with polarised light.

Information regarding the birefringence of the wafer and the strain fields within the wafer may also be determined by imaging the wafer between two crossed polarisers, i.e. a linear polariser arranged each side of the wafer, the two polarisers being arranged so that they transmit light of a different polarisation orientation. The polarisers may be arranged in an orthogonal arrangement so that one polariser transmits light which has an orthogonal polarisation to light emitted by the other polariser. FIG. 8 shows a scanned image of a 76 mm diameter SiC wafer which was taken in transmission mode with crossed orthogonal polarisers. The only light which reaches the detector is that for which the direction of polarisation has been changed due to interaction with the wafer. The skilled person will appreciate that strain in the wafer can cause such a polarisation rotation and hence the image indicates the amount of strain present in the wafer and the location of the strain fields. Defects may also cause a polarisation shift and hence defect position also shows up clearly. Whilst orthogonal crossed polarisers are useful in some instances it may be wished to use other alignments, e.g. polarisers having their polarisation axis offset by 45° or some other amount or aligned polarisers where both polarisers have their polarisation axes aligned.

The present invention therefore provides a simple and low cost solution to wafer inspection using commercially available scanners.

1. A method of inspecting a substrate comprising the step of scanning the substrate with a PC scanner having negative image scanning capability so as to record the intensity of light transmitted through the substrate.

2. A method as claimed in claim 1 wherein the PC scanner comprises a detector array having a number of elements receiving light at different wavelengths.

3. A method as claimed in claim 1 wherein the substrate is a semiconductor wafer.

4. A method as claimed in claim 1 wherein the substrate is an optical thin film.

5. A method as claimed in claim 1 wherein the substrate is a display device.

6. A method as claimed in claim 1 wherein the substrate has at least one epi layer.

7. A method as claimed in claim 1 wherein the substrate is substantially transparent at visible wavelengths.

8. A method as claimed in claim 1 wherein the substrate is substantially transparent at infrared wavelengths and the method comprises illuminating the substrate with infrared radiation.

9. A method as claimed in claim 1 wherein the substrate is formed from one of SiC, AI₂O₃, GaN, AIN, InN, STO, Si, Ge, MgO, GaP, AIP, ZnSe, CdTe, ZnTe, CdSe, GaAs, InP, InSb, GaSb, AISb, InAs, AIAs, SiO2.

10. A method as claimed in claim 1 comprising the step of identifying and measuring interference fringes in the recorded intensity pattern.

11. A method as claimed in claim 1 wherein the method involves the step of comparing the intensities recorded at different wavelengths.

12. A method as claimed in claim 11 wherein the thickness or optical constant of the substrate or an epilayer are determined by comparing the intensities at different wavelengths.

13. A method as claimed in claim 1 wherein the detected intensities are used to determine at least one of the magnitude of wafer curvature, variations in substrate thickness, wafer surface morphology, variations in epilayer thickness, surface particulate and/or scratch density and location and or density of crystallographic defects such as micropipes and crystal tilts.

14. A method as claimed in claim 1 comprising the step of arranging the detector array of the PC scanner to only receive radiation of a particular polarisation.

15. A method as claimed in claim 1 comprising illuminating the substrate with polarised radiation.

16. A method as claimed in claim 1 comprising the step of arranging a polariser between the light source of the PC scanner and the substrate and/or a polariser between the substrate and the detector array of the PC scanner.

17. A method as claimed in claim 16 wherein the polarisers are arranged in the optical path in a crossed configuration.

18. A method as claimed in claim 1 wherein the substrate has at least some device structure fabricated thereon.

19. A method of determining the thickness and/or curvature of a wafer layer comprising the steps of using a PC scanner to obtain an image of the wafer, detecting and measuring interference fringes in the image and, from said measurements, determining the thickness and/or curvature of said wafer layer.

20. A method as claimed in claim 19 wherein the PC scanner obtains the image of the wafer in reflection mode.

21. A method as claimed in claim 20 where the PC scanner is a flatbed scanner.

22. A method as claimed in claim 19 further comprising the step of analysing the image formed by each wavelength channel of the scanner detector array separately.

23. A method as claimed in claim 19 comprising the step of imaging the wafer on an optical flat to determine surface curvature.

24. A method as claimed in claim 19 further comprising the step of determining the refractive index of the wafer.

25. A method of imaging a wafer using a PC scanner wherein at least one polariser is located in the optical path from the source to detector.

26. A method as claimed in claim 25 wherein a polariser is located between the source and the wafer so as to illuminate the wafer with polarised light.

27. A method according to claim 25 comprising the steps of taking one image of the wafer with polarised light of one polarisation state followed by a second image using polarised light of a different polarisation state.

28. A method according to claim 27 wherein the different polarisation states are orthogonal linear polarisations.

29. A method according to claim 25 comprising locating one polariser between the light source and the wafer and another polariser between the wafer and the detector.

30. A method according to claim 29 wherein the polarisers are linear polarisers and are arranged in a crossed polariser configuration.

31. A method according to claim 25 wherein the or each image recorded is analysed to determine the degree of birefringence of the wafer and/or the amount of strain in the wafer.

32. A method of analysing a wafer comprising the step of stimulating luminescence within the wafer whilst imaging the wafer using a PC scanner.

33. A method according to claim 32 wherein the step of stimulating luminescence comprises irradiating the wafer with radiation having an appropriate wavelength to stimulate photoluminescence.

34. A method according to claim 32 where the step of stimulating luminescence comprises electrically stimulating electroluminescence within the wafer.

35. A method according to claim 34 where the light source of the scanner is disconnected during image acquisition so that only electroluminescence is detected.

36. A computer program provided on a computer readable medium with instructions for controlling a scanner arranged to perform the method of claim 1.
